(19) United States
(12) Patent Application Publication
(10) Pub. No.: US 2017/0358012 A1
(43) Pub. Date: Dec. 14, 2017

(54) Website Content Preserver

(71) Applicant: Brian Vallelunga, Santa Cruz, CA (US)

(72) Inventor: Brian Vallelunga, Santa Cruz, CA (US)

(21) Appl. No.: 15/182,286

(22) Filed: Jun. 14, 2016

(51) Int. Cl. G06Q 30/02; H04L 29/08; H04L 29/12

(52) U.S. Cl. CPC G06Q 30/0276; H04L 61/1511; G06Q 30/0277; H04L 67/02

(57) ABSTRACT

The present invention describes a system and method for preserving web content from 3rd party blockers. The preferred embodiment will protect website content elements in the HTML/Javascript of the user experience in browsers and mobile apps through dynamic changes in the element url and label names and encoding of image data.

### BACKGROUND

### Field of the Invention

The present invention relates to web content provider web page integrity, and more particularly for prevention of 3rd party interference or vandalism to protected web browser content.

Advertiser

Ad blocking or ad filtering is removing or altering web publisher content in a webpage. Content can exist in a variety of forms including pictures, animations, embedded audio and video, text, or pop-up widows and can employ autoplay of audio and video. All browsers offer some solution to the problem, either by targeting that are used to deliver content, targeting URLs that are the source of content, or targeting behavioral characteristic of content such as the use of HTML5 autoplay of both audio and video.

Ad-Blocker Vandalism Schema

Most ad-blocking software installs a proxy client-server on a user's computer or browser and routes all of the data to/from the user's browser through the proxy server. The proxy server may then filter out the user browser requests that attempt to download images etc. from ad servers. It may also modify the incoming HTML pages to strip out JavaScript code that looks like it might be for advertising purposes.

Websites commonly used to circumvent filters and access blocked content often include a proxy, from which the user can then access the websites that the filter is trying to block. Alternatively a content-filtering web proxy server provides administrative control over the content that may be relayed in one or both directions through the proxy. Requests may be filtered by several methods, such as a URL or DNS blacklists URL regular expression filtering, MIME filtering, or content keyword filtering. Some products have been known to employ content analysis techniques to look for traits commonly used by certain types of content providers. Blacklists are often provided and maintained by web-filtering companies, often grouped into categories.

If the requested URL is acceptable, the content is then retrieved by the proxy. A dynamic filter may be applied on the return path. For example, JPEG files could be blocked based on fleshtone matches, or language filters could dynamically detect unwanted language. If the content is rejected then an HTTP fetch error may be returned to the requester.

Most web filtering companies use an internet-wide crawling robot that assesses the likelihood that a content is a certain type. The resultant database is then corrected by manual labor based on complaints or known flaws in the content-matching algorithms.

At the simplest level, ad-blocking software causes each request for data to be inspected for URLs of a known ad-server. The request to an ad-server, as the proxy server does for normal web browser requests, is discarded and response to the browser returned is that the requested data could not be found, or a bogus image is sent back to the browser corrupting the originally served page. Thus the ad request never makes it to the ad server and the browser does not display an ad, resulting in the cyber vandalism “takeover”.

More sophisticated ad-blockers go beyond simply filtering out certain data requests coming from the browser. Some will actually modify the HTML and JavaScript code from a requested page as it passes through the proxy server in order to remove JavaScript code that creates pop-up windows, etc.

Many pop-up ads are Javascript applications that open a new browser window containing new content. The new window appears on top of the user's current view, obscuring the Web page actually called to see.

Most Ad blockers are content filters that rely on predefined filter lists to identify and remove ads. They work by compiling lists of expressions associated with ads and using pattern matching to compare those against outgoing requests made by the user's browser.

Ad content blockers may also block tracking scripts, which in turn prevent third-party ad networks from delivering content to a user's browser by way of the publisher's site. Before the page is rendered, the ad blocker modifies it, strips off the request to the ad service or tracking scripts and injects CSS to repair the site so it doesn't look broken. To the user there's no evidence that the page had been altered.

Because they interrupt communications with third-party ad networks, dedicated tracking blockers also block ad content from those sources by examining the host name for any outgoing browser request and blocking requests to hosts associated with ad networks that track users' activity across the Web. The intent is to block tracking, not ads.

Content Provider Response

Some websites have taken counter-measures against ad-blocking software, such as attempting to detect the presence of ad blockers and informing users of their views, or outright preventing users from accessing the content unless they disable the ad-blocking software. Advertisers assert that blocking ads is will eventually make way to the subscription model. One content provider presented an option for an ad-free experience, to which less than 1% of the 4 million unique monthly visitors signed up for the $2.99/month subscription. Hence there does not seem to be large user support for maintaining content provider web page integrity and other measures are needed.

Content providers respond that widespread ad blocking results in decreased revenue to a website sustained by advertisements. A widely accepted 2015 report estimated the cost to publishers in 2016 alone could be as much as $22 billion. One ad blocker claims to have 60 million users worldwide. One ad blocker claims that about 6% of all Web users in the U.S. run its open-source software, mostly in the form of Google Chrome and Firefox browser add-ons, plugins and extensions.

Ad content blockers could spell the end for much of the free user web content, making content providers unable to be profitable by taking away their business sustaining advertising revenue. What is needed are ways to allow advertisements to pay for the web content which can then be given to users without cost. What are needed are ways to prevent ad content blockers from blocking legitimate ads.

### SUMMARY

The present invention discloses a system and method for preserving web content from 3rd party blockers. The preferred embodiment will protect advertising components of the user experience in browsers and mobile apps. This begins with a user with an app or browser on a network requesting a display website's URL page or URL respectively, the website has a registered DNS subdomain and domain known to an Ad Provider and the website has agreed with Ad Provider to using a dynamically alterable path to Ad Provider serving advertising content to website users. The ad provider creates a program dynamically altering the website ad content elements comprising ad links, CSS elements, images and ad element labels, giving a randomized programming to the ad content elements, an ad provider's server created program downloads to the user's browser upon request, adaptively changing the website ad component elements to the randomized name elements. The user's browser executes the ad server program dynamically altering the display website page, and the user's browser or mobile app executes the altered display website page or URL respectively with the changed ad components and publishes the website page whereby the advertiser content is protected from subverting blockers targeting provider ad content.

### BRIEF DESCRIPTION OF DRAWINGS

Specific embodiments of the invention will be described in detail with reference to the following figures.

FIG. 1 shows a block diagram showing the hardware components of the wireless client device in accordance with an embodiment of the invention.

FIG. 2 is a smart wireless device with environment for mobile applications, AKA apps, and operating system internal architecture in accordance with an embodiment of the invention.

FIG. 3 shows a high level block diagram of content preservation in an embodiment of the invention.

FIG. 4 block flow diagram illustrates a typical user downloading and executing a webpage from an external server for display locally in user browser in an embodiment of the invention.

FIG. 5 illustrates a browser execution of a webpage from an external server for display locally in an embodiment of the invention.

FIG. 6 illustrates an ad loader script execution in a webpage from an external server for display of content locally in an embodiment of the invention.

FIG. 7 flow diagram illustrates an ad server execution from a webpage for an external ad server content delivery for user display of content locally in an embodiment of the invention.

FIG. 8 flow diagram illustrates an ad server dynamically generated java script unique to a website host and user browser in an embodiment of the invention.

FIG. 9 flow diagram illustrates logic for mobile content preservation in an embodiment of the invention.

### DETAILED DESCRIPTION

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

### Objects and Advantages

The present invention discloses methods for overcoming browser content blockers. In particular an object if the invention is to prevent Ad content blockers from altering tracking scripts to preventing third-party ad networks from delivering content to a user's browser by way of the publisher's site.

Another object is to introduce misdirection to prevent hackers from altering the content provider tracking scripts or requests to 3rd party servers and thus from altering the request to an ad service or tracking scripts and modifying the content provider site CSS.

Yet another object of the invention is preserving outgoing browser requests from blocking by user of hosts name strings associated with ad networks.

Another object is to bypass content-filtering web proxy servers from filtering by URL name, DNS blacklists strings, URL regular expressions, MIME, or content keywords.

An object of the invention is to employ name sting randomization changes to circumvent 3rd party categorization of content.

Yet another object of the invention is to use proxy servers to route data to/from a user's browser to alter the user browser requests that attempt to download images blacklisted 3rd party servers.

Another object of the invention is to modify website HTML JavaScript code file name to obscure function.

Another object of the invention is to encode content by name identifiable JavaScript input parameters for JavaScript code.

### Embodiments of the Invention

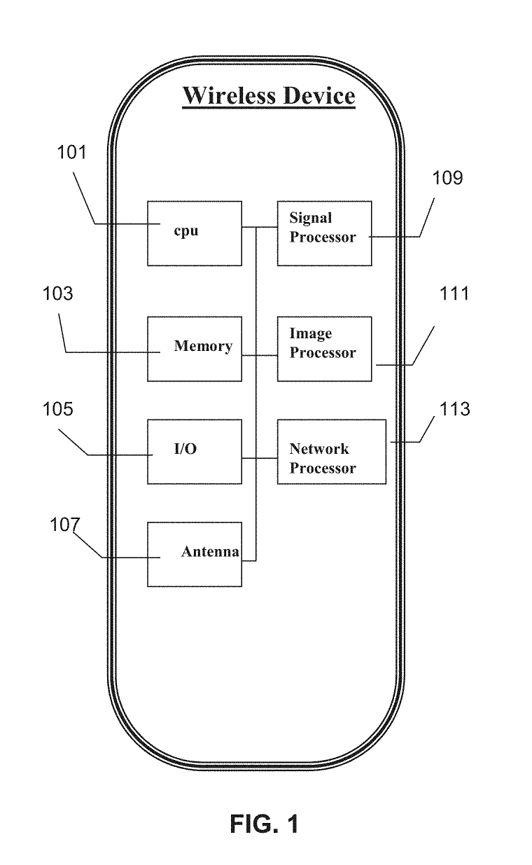

FIG. 1 is a high level block diagram showing the hardware components of the wireless client device in accordance with an embodiment of the invention.

Hardware components facilitate certain programming functions. Executing in the CPU 101 browsers receive instructions and data from external sources via a signal processor 109. Mobile programs are downloaded via I/O processor 105 at which time user browser execute 101 the apps per the browser program. Mobile App users 105 are motivated to use the downloaded and upon execution and authorization, the user apps 105 report activity parameters characteristic of the app to the 109 website via the Internet 107 or other intermediary network. Data is collected, organized and stored and transferred 109 to servers in real-time. Asynchronously and independently, venders data and programs can be stored in memory 103. I/O 105 can include sensors and USB or other protocol devices.

The user device may include and image processor 111 and a network processor 113 to carry out the various functions of connecting, downloading and displaying images or video carrying advertising value.

Mobile Apps

Not all mobile apps use the mobile device sensors 105 to provide clues about mobile user activity but many do. Examples of some apps that use mobile device sensors are: golf, base ball, cricket, tennis, hiking, jogging, running, walking, GPS tracking, GPS driving, jump rope, exercise, volley ball, table tennis, virtual mobile game, mirror, compass, level, measuring tape, video, movies, TV Guide, pedometer, speedometer, photography and more. It would almost appear the apps are only limited by imagination, as they are creative and useful. In addition, mobile browser apps provide access to many web apps as well thought the HTTP/HTML/Javascript protocol and language. Even with encryption messages can be intercepted by 3rd parties and decrypted.

FIG. 1 shows a block diagram showing the hardware components of the wireless client device in accordance with an embodiment of the invention. The embodiments of the invention can be implemented on virtually any type of computing device executing a browser including a wireless computing device regardless of the platform being used providing the performance, storage, display and bandwidth requirements are sufficient. For example, as shown in FIG. 1, wireless device 120 includes a processor CPU 101, associated memory 103, a I/O processor/bus 105, network adaptor 113, Digital Signal Processor(s) 109, antenna 107 and associated circuitry and numerous other elements and functionalities typical of today's smartphones (not shown). The wireless device 120 may also include input means, such as a keyboard, not shown, and a light pencil, not shown, and output means, such as display, The wireless device 120 must be network connectable to a local area network (LAN) or a wide area network (e.g., the Internet) (not shown) via a network interface 113. Those skilled in the art will appreciate that these input and output means may take other forms.

The I/O processor/bus 105 can service many devices and sensors including but not limited to sensors such as 3D accelerometers, gyroscopes, touch screen, motion sensors, light sensors, proximity sensors, wireless communication, audio subsystem, camera, video, ultrasonic sensor, and others. These devices and sensors are all sources of primary information for mobile app activities to be used in embodiments of the invention.

Further, those skilled in the art will appreciate that one or more elements of the aforementioned wireless device 120 may be located at a remote location and connected to the other elements over a network. Further, software instructions to perform embodiments of the invention may be stored on the device computer readable medium such as a compact disc (CD), a memory stick, a file, or any other computer readable storage device in communication with the wireless client.

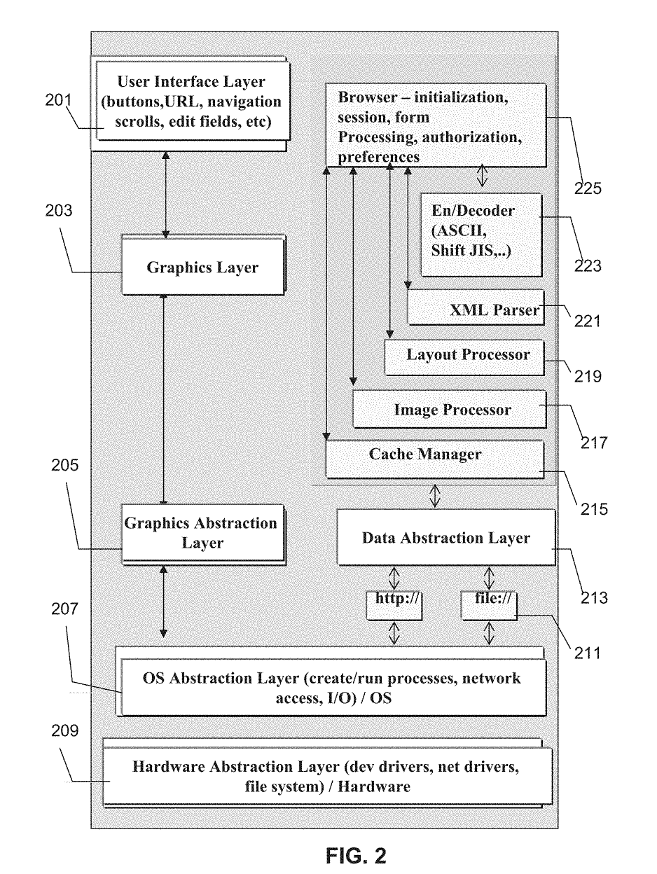

FIG. 2 is a smart wireless device with environment for mobile applications, AKA apps, and operating system internal architecture in accordance with an embodiment of the invention.

The User Interface (UI) layer 201 supports buttons, key pads, touch screen and other I/O, URLs navigation, an application framework for scroll bars, edit fields, text areas, etc. The graphics layer 203 comprises encoder/decoder 223, XML parser 221, Layout processor 219, Image processor 217 and cache manager 215. These all support event managers, window manager, graphical primitives, display manager for supporting the browser 225 functions. These software entities are all configurable in many memory footprints. The graphics abstraction layer 205 interfaces with the wireless device Operating System 207 (OS) for process creation, network access, I/O and other OS functions. The data abstraction layer 213 interfaces the http and file calls and protocols to the OS 207 layer which ultimately directs the hardware 209 to physically carry out the I/O and internal device functions.

FIG. 2 also shows a wireless device internals architecture supporting a UI with a menu and keypad. In an embodiment of the invention, the menu supports a browser menu environment. Many mobile browsers are highly customizable allowing the addition of many interface languages within a multilingual environment. The interface design has editable menus and customizable user roles and file upload types which can support embodiments of the invention and are known to those skilled in the art.

In another embodiment, the browser is pre-configured to allow startup by using it directly after completing the set-up process. The user interface and support function environment provides adding different file types, adding menus and changing the look and feel of the installation. The look and feel and general menus are configured once by vendor but can be altered in different versions and products. Hence, browser program user controls are provided to interface with downloaded webpage execution for input regarding defined functions operating on specific mobile display screen area showing ads.

A lockdown of the browser or applications can be implemented in some embodiments to increase security or customize the device to prevent unknown interferences or enable quicker response through un-encrypted or lightly encrypted communication.

The remote client browser then is coupled, by programming it, to support chosen standard communication protocols or proprietary protocols to connect the client to the local content servers, giving access to local metadata cache, relevant to a particular application from a server's profile views.

For smart phones or mobiles, the mobile Operating System OS, may include but is not limited to Apple's iOS, Android, Linux, Windows, CE, Symbian, RIM, Java, and others environments, so long as a standard browser is used as shown in FIG. 2. Alternatively, user computer implementations may use Windows, AppleOS, OS X. Linux, Unix and Linux variants and other OSs which are executing an HTML/HTTP browser.

Universal Resource Locator

A web browser is a software application for retrieving, presenting, and traversing information resources on the WWW. A Universal Resource Locator (URL) a pointer to a webpage, image, video or other piece of content. As such URLs can be part of labels of Document Object Model (DOM) elements to be called upon user action in reaching for content in various forms. Hyperlinks present in resources enable users easily to navigate their browsers to related resources.

Objects in the DOM tree may be addressed and manipulated by using embodiment methods on the objects. With the object model, JavaScript is fully enabled to create dynamic HTML. Embodiment JavaScript can add, change, and remove all the HTML elements and attributes in the page. Aspects of the embodiment JavaScript can will change some the CSS styles in the page. Aspects of an embodiment JavaScript will react to events in the page and create new events in the page.

The web browser retrieves any content at the URL and renders the content to the user. This begins when the user clicks or taps on a hyperlink or inputs a URL into the browser. The prefix of the URL, the Uniform Resource Identifier or URI, determines how the URL will be interpreted. The most commonly used kind of URI starts with http: and identifies a resource to be retrieved over the Hypertext Transfer Protocol (HTTP). Many browsers also support a variety of other prefixes.

In the case of http, https, file, and others, once the resource has been retrieved the web browser will display it. HTML and associated content, image files, formatting information such as CCS, etc., is passed to the browser's layout engine to be transformed from markup to an interactive document, a process known as “rendering”. Aside from HTML, the browser can generally display any kind of content that can be part of a web page. Most browsers can display images, audio, video, and XML files, and often have plug-ins to support Flash applications and Java applets. Certain portions of the actual logic or code can be programmed in native mode in place of javascript code in mobile apps, an aspects of the invention are not restricted to javascripts.

Information resources may contain hyperlinks to other information resources. Each link contains the URI of a resource location. When a link is invoked, the browser navigates to the resource indicated by the link's target URI, and the process of bringing content to the user begins again.

Table A below defines some components and entities discussed further.

TABLE A
Definitions

| Name | Definition |
|---|---|
| Browser | A program with a graphical user interface for |
| | displaying HTML files, using HTTP and used to |
| | navigate the World Wide Web. |
| | eg: Chrome, Firefox Safari, IE |
| URL | An address that specifies where the browser or |
| | device should request content. |
| Website | A graphical representation for displaying HTML |
| | to a user |
| Inline Javascript | Javascript that is contained within the HTML code |
| iFrame | An inline frame used to embed another document |
| | within the current HTML document. |
| Host (Ad displayer) | The URL of the origin content provider. |
| | For example, if a user goes to the NY Times |
| | website, than the host would be the |
| | NY Times root domain of the URL. |
| Host Admin | An person who has admin privileges for a |
| | host.computer |
| Host Ad Subdomain | A subdomam used to route ad traffic provided by the |
| | host. eg. NY Times would have a ad subdomain as |
| | https://<AD_SUBDOMAIN_KEY>.nytimes.com |
| AD_SUBDOMAIN_ | A label used to specify which host is requesting |
| KEY | ad traffic. This key can be stored on an Ad |
| | Provider's database |
| Ad Provider | A central provider for ads. (eg. Google, |
| | DoubleClick, Yahoo, MS, Apple) |
| Ad Provider's API | The domain where all ad traffic will be routed to. |
| | eg: doubleclick.com, ads.google.com, ads.yahoo.com |
| Ad Provider Portal | A portal that provides the capability to |
| | install/update/remove Ads on controlled websites |
| Ad Provider's Server | The server that responds to all Ad traffic requests. |
| Ad Loader Script | A script that decides which URL to use to |
| | download the Ad Script. It may first try the Host Ad |
| | Subdomain before the Ad Provider's Domain |
| Ad Script | A script that contains all the necessary information |
| | to place ads on hosts site This script will find |
| | HTML elements that are designated for Ad display |
| | and inject an Ad into them |
| AD_KEY | ID used to specify which Ad to display to the user. |
| Advertiser | A business entity purchasing ads from an Ad |
| (Vendor) | Provider |
| User (Browser) | The ultimate displayer/viewer of Host content |

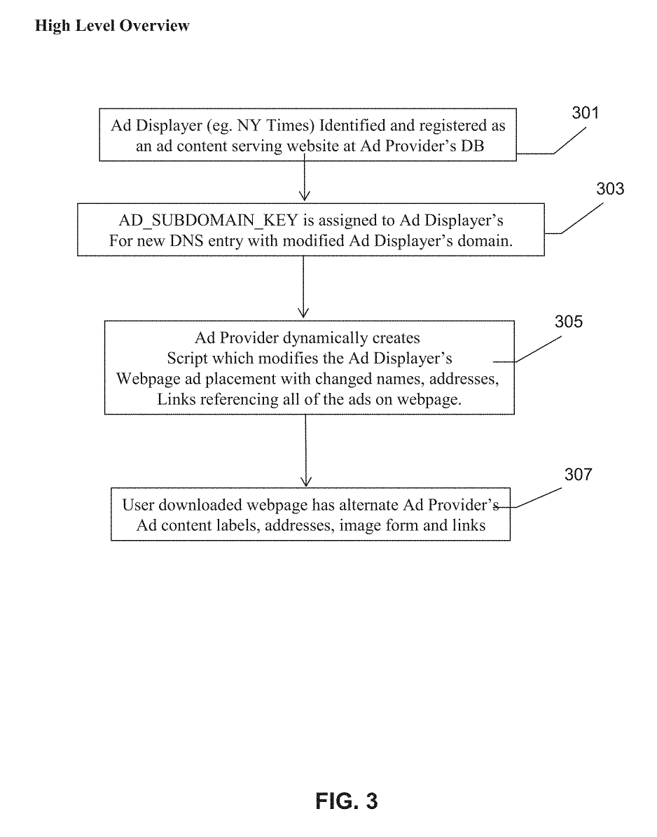

FIG. 3 shows a high level overview of content preservation in an embodiment of the invention. A properly identified Ad Displayer or Host 301 (eg. NY Times) would need to create an alternate routing path via subdomain/domain that is known to the Ad Provider. Thus the Ad Displayer would register as an ad content serving website with an Ad Provider's DB which is consulted programmatically for ad traffic. This would entail also registering this new subdomain.domain with the DNS database. Example domain names would be NYtimes.com or ads.google.com. Subdomain names can be most any alphanumeric string, for example AABBCC123. A subdomain for any domain simply prepends the string to obtain the URL, for example http://AABBCC123.NYtimes.com. The domain name can also have wildcards, which would be useful to accommodate more than one domain with the same URL. Thus in an embodiment of the invention wildcards are placed in subdomain entries for DNS resolution

Domain Name Service (DNS) is a decentralized naming system for computers, services, or any resource connected to the Internet or Private Network. It associates various information with domain names assigned to each of the participating entities. Most prominently, it translates more readily memorized domain names to the numerical IP addresses needed for the purpose of locating and identifying computer services and devices with the underlying network protocols.

When a user accesses a distributed Internet service using a URL, the domain name of the URL is translated to the IP address of a server that is proximal to the user. The key functionality of DNS exploited here is that different users can simultaneously receive different translations for the same domain name. This process of using DNS to assign proximal servers to users is key to providing faster response times on the Internet and is widely used by most major Internet services today.

A domain name consists of one or more parts, technically called labels, that are conventionally concatenated, and delimited by dots, such as NYtimes.com. The right-most label conveys the top-level domain; for example, the domain name www.example.com belongs to the top-level domain com. The hierarchy of domains descends from right to left; each label to the left specifies a subdivision, or subdomain of the domain to the right. For example: the label NYtimes specifies a subdomain of the com domain. This tree of subdivisions may have up to 127 levels.

A label may contain zero to 63 characters. The null label, of length zero, is reserved for the root zone. The full domain name may not exceed the length of 253 characters in its textual representation. In the internal binary representation of the DNS the maximum length requires 255 octets of storage, since it also stores the length of the name.

In an aspect of the invention a label known to the Ad Displayer Host and the Ad Provider, named AD_SUBDOMAIN_KEY is assigned 303 to Ad Displayer's for a new DNS entry for an alternate Ad Displayer domain. The Ad Provider 305 dynamically creates a program which modifies the Ad Displayer's Webpage on with changed names, addresses, links referencing all of the ad content components and elements on the Host webpage. Thus when the User downloads 307 the Host webpage it has alternate Ad content labels, addresses, image forms and links

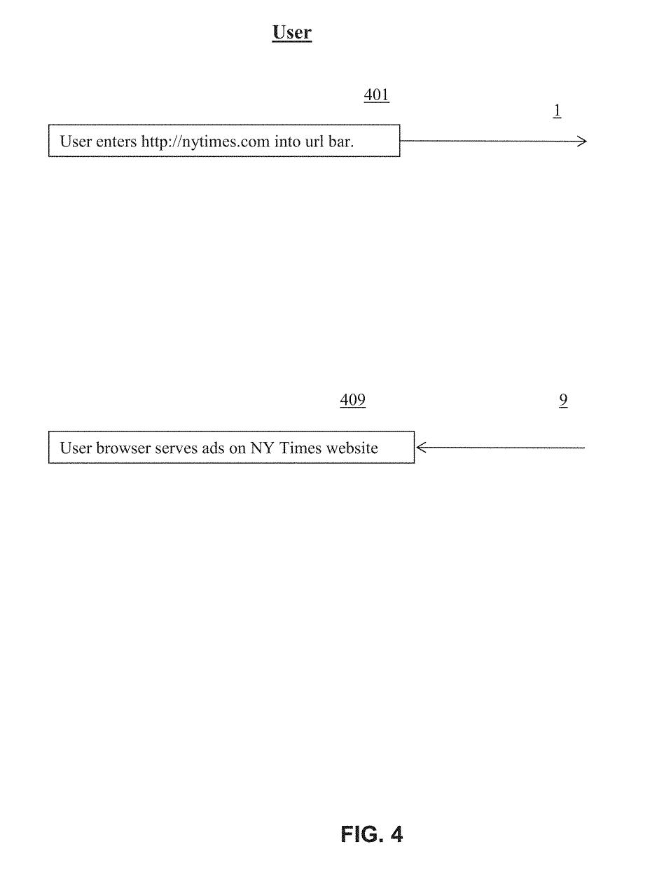

FIG. 4 illustrates a typical user requesting 401 a webpage from an external server, eg. NY Times.com, for display locally in user browser in an embodiment of the invention. The control flow 1 threads to the user's browser to the URL website. The display host responds 409 with all content on its webpage preserved and without alteration or reduction of content from a 3rd party attempting to interfere. The control flow 9 threads from the external server display host.

Although domain names may theoretically consist of any character representable in an octet, host names use a preferred format and character set. The characters allowed in their labels are a subset of the ASCII character set, consisting of characters a through z, A through Z, digits 0 through 9, and hyphen. This rule is known as the LDH rule, letters, digits, hyphen.

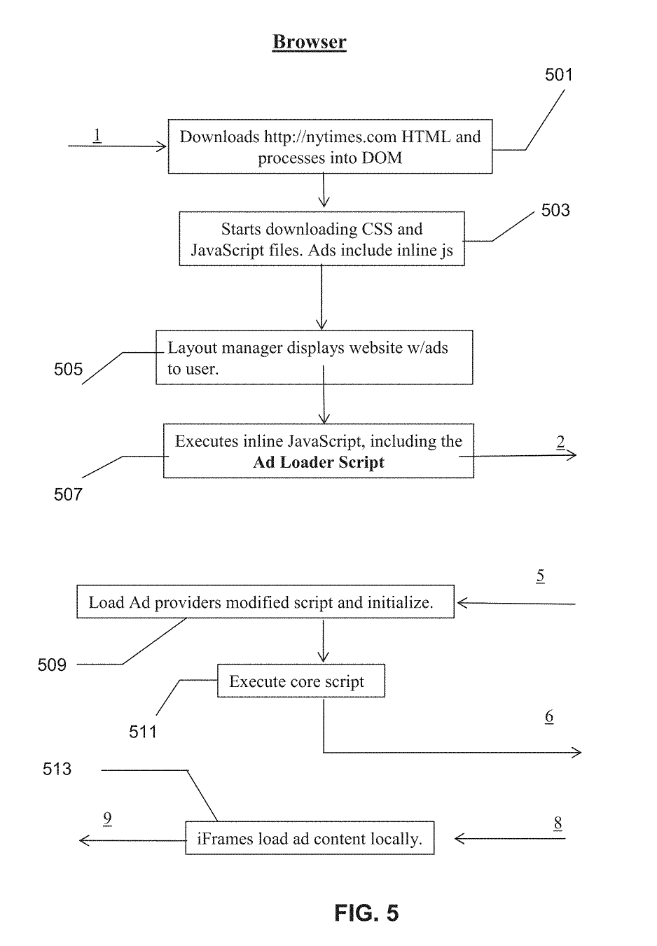

FIG. 5 illustrates a browser execution of a webpage from an external server for display locally in an embodiment of the invention. Upon user request 1 from the Host display URL, the user's browser will download 501 the host webpage HTML, eg. http://nytimes.com, and process into DOM with all of the elements, components, ad content locations. The browser will then download 503 the CSS and Javascript files which include any inline JavaScript. The browser Layout manager will then render the website 505 with ads to the user, executing the inline JavaScript, making modifications to the Ad Loader Script 507 altered for forwarding ad traffic to the Ad Provider's Server.

Wildcard DNS Records

The domain name system supports wildcard DNS records which specify names that start with the aiterisk label, ‘*’, e.g., *.NYtimes. DNS records belonging to wildcard domain names specify rules for generating resource records within a single DNS zone by substituting whole labels with matching components of the query name, including any specified descendants. For example, in the DNS zone abc123.NYtimes, the following configuration specifies that all subdomains, including subdomains of subdomains, of abc123.NYtimes use the mail exchanger a.abc123.NYtimes. The records for a.abc123.NYtimes are needed to specify the mail exchanger. As this has the result of excluding this domain name and its subdomains from the wildcard matches, all subdomains of a.abc123.NYtimes must be defined in a separate wildcard statement. Thus subdomains can be added and used with some dynamic randomness for some intents and purposes to evade tracking and listing by blockers. In an aspect of the invention subdomain labels can be chosen with wildcards to randomize the URLs somewhat to confuse 3rd party subverting blockers in using subdomain labels for DNS resolution.

On a response 5 from the Ad Provider's Server 509, the browser will then load the Ad provider's modified javascript and initialize, following by execution of the core Ad script 511 with the Ad provider's changes and additions to certain webpage HTML elements containing path clues to protected content.

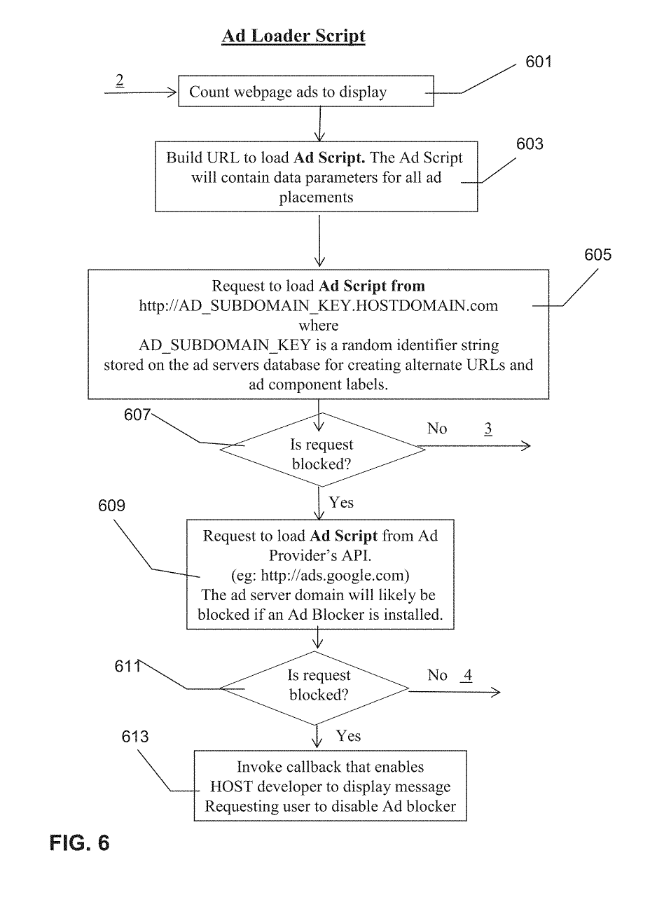

FIG. 6 illustrates an ad loader script and execution for a webpage from an external server for display of content locally in an embodiment of the invention. The thread logic continues from a browser 2. Upon execution the script will count the content 601 to be protected. In an embodiment of the invention the content element comprise advertising content and information regarding ad content. This count will be used in iterating through the HTML elements to be changed. The URL to load the Ad Script 605 will be created and contain data parameters representing the number of ads to display. The script logic created will attempt to load the URL 607 with a prepended subdomain(s) to the host domain 605. An example using the NYtimes.com domain and a randomized subdomain of 123xyz will create a new URL http://AD_SUBDOMAIN_KEY.HOST_DOMAIN_KEY.com or http://123xyz.NYtimes.com. The AD_SUBDOMAIN_KEY 123xyz is typically a random identifier stored on the Ad Provider's database and dynamically replaceable. If Ad Loader Script URL load succeeds 3 the execution thread will flow to the Ad Provider's Server for ad processing. If the attempt to load 607 is blocked, then the thread logic proceeds to request 611 URL to load from the Ad Provider's API 609, for example http://ads.google.com. This URL 609 can be blocked 611 as these URLs are well known ad servers and 3rd parties can redirect or block these request attempts to disrupt host content. Well known Ad Provider and advertiser domains are placed on blocker lists, which are consulted by ad blocker programs. But some escape this and if not blocked 611 then the logic threads 4 to the Ad Provider's server. If URL request 611 is blocked the script logic can invoke a callback 613 the enables the HOST to display a message requesting the user to disable the 3rd party blocker.

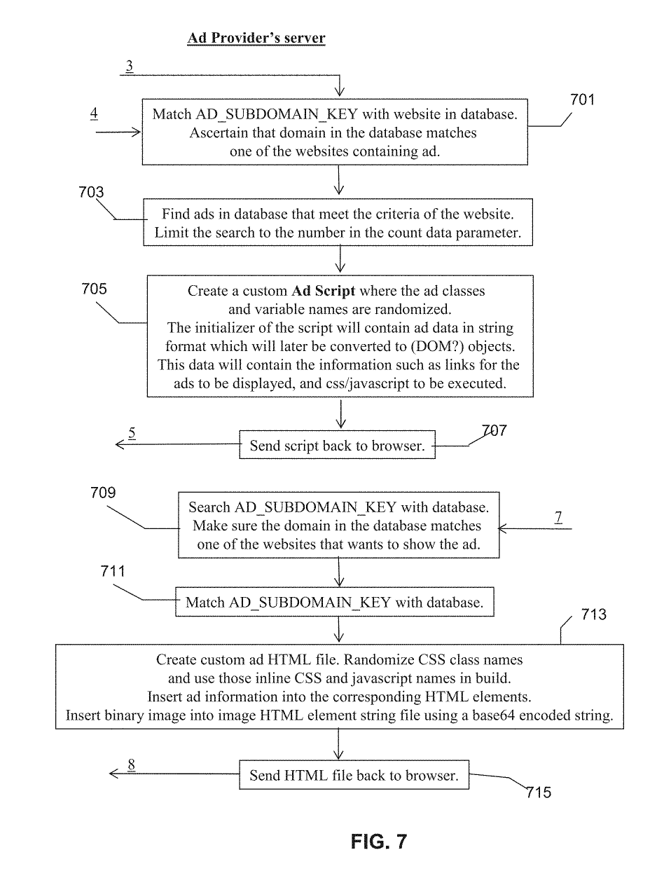

FIG. 7 illustrates an ad server's execution from a webpage requesting external ad server content delivery for user display of ad content locally in an embodiment of the invention. The Ad Provider will search 701 for AD_SUBDOMAIN_KEY in it's server database to ascertain that display website domain is in the DNS database and matches one of the websites containing ads. The number of website ads found 703 should match the ad count in the display website page, meeting the criteria of the website. The Ad Provider programmatically creates a custom Ad Script 705 or program to be merged into the display website page whereby the ad content components, ad classes including CSS and ad component variable names are prepended or changed to include the AD_SUBDOMAIN_KEY string. User invocation of any ads in the website page would thus be tracked for billing purposes and hence a core ad library is created dynamically for the ad script. The initializer of the script or program will contain ad data in string format which will be converted to DOM objects. Any of these DOM elements can be blocked by 3rd party blockers. However this data will contain the information such as links to the ads to be displayed and javascript to be executed and css and class variable name components for ads, albeit with different names. The ad script is sent back to the user browser 707 as requested for execution 5 by the user's browser.

Once the user browser executes the ad script, execution thread 7 requests that the ad provider's server search for the AD_SUBDOMAIN_KEY string in the Ad Provider's ad database 709. A match will confirm that the domain of the website wishes to display an authentic advertisers ad 711. The ad provider server will dynamically create an ad HTML file with the randomized CSS class name changes for the ad components and inline CSS and javascript labels replacing the original website ad or blocked elements. For example, ad1.myClass (color.red) would be changed to AABBCC123.myClass (color.red) with the randomized string “AABBCC123” substituted for the original ad component variable label. Any ad binary image components are transformed into strings using base64 encoding, for example ad_image.png is changed to an ad_image.png base64encoded string. Other encoding schemes can be used for image file transformations. The response to user requests for ad information in the form of CSS class, JS, HTML, Images, data and files is effectively changed dynamically 713 and the HTML file 715 is sent back 8 to the user browser 715 to be executed there.

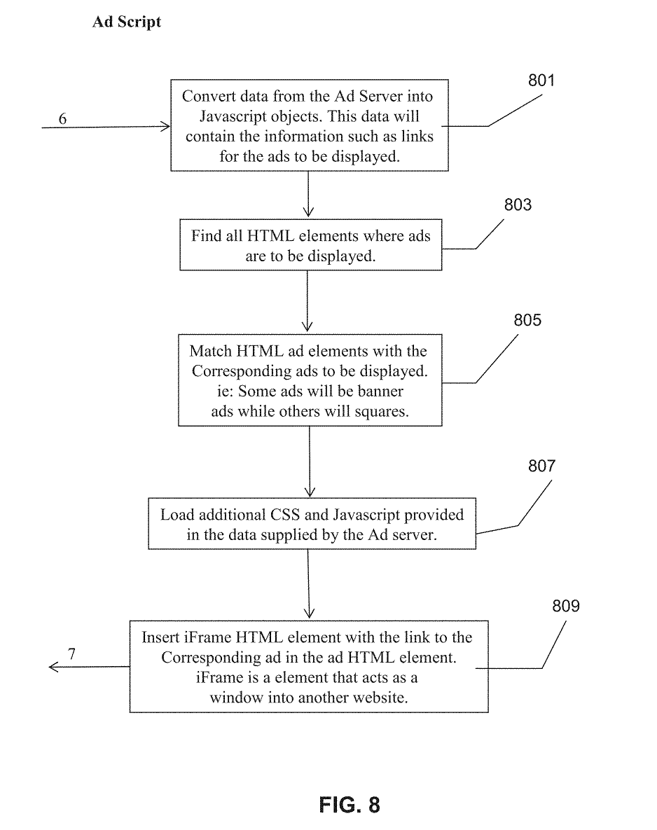

FIG. 8 illustrates an ad server dynamically generated java script flow diagram unique to a website host and user browser in an embodiment of the invention. Execution logic flows from user browser loading, initializing and executing the core javascript from the Ad Providers 6. The Ad Provider's javascript converts data from the Ad Server into Javascript objects 801. This data contains the information elements such as resource links for the ads to be displayed. The links have been altered to further bypass 3rd party interference. For example an image is downloaded from htttp://ad.google.comfimages/AABBCC123.png will be blocked. But the URL htttp://AABBCC123.NYtimes.com/images/AABBCC123.png will not be blocked because it is now being routed through the subdomain of the website. The javascript or program then identifies all HTML elements where the ads are to be displayed 803. For example all elements with a CSS class of AABBCC123 will be identified as elements to have ads displayed in them. Notice that this CSS class is not using or mentioning ads or any other keyword that a content filtering program would detect that is associated with advertising.

The HTML ad elements are match compared 805 with the corresponding ads of the website to be displayed. Ads are unique and fall in different categories and sizes. These must be accounted for and handled separately. Additional CSS and Javascript data provided in Ad Provider server is loaded 807. An iFrame HTML element with its corresponding ad is inserted 809. This <iframe> defines a rectangular region within the document in which the browser can display an ad and acts as a window into another website. The inserted src attribute specifies the URL of the ad that occupies the inline frame. This terminates the script and move execution flow to the Ad Provider server 7.

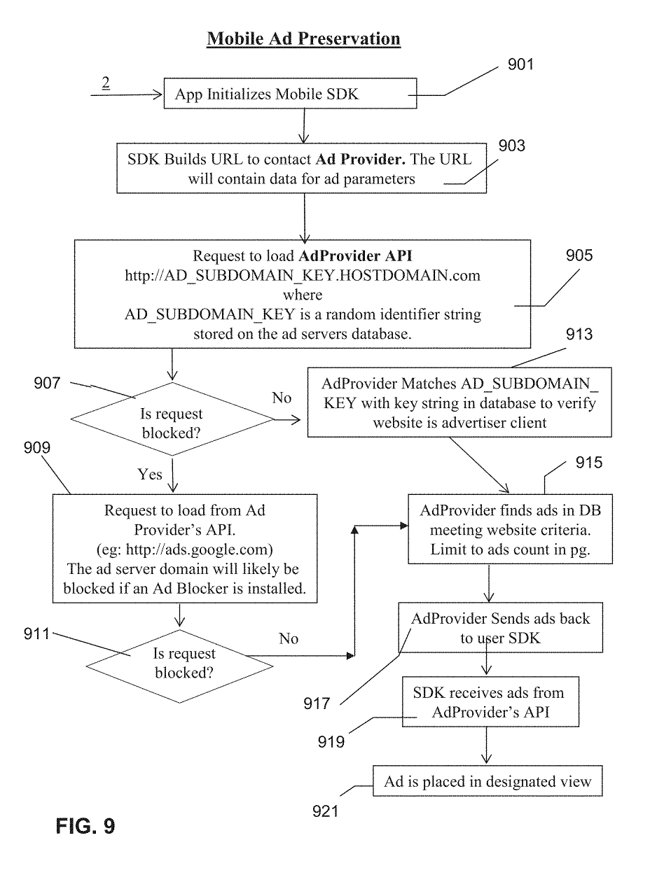

FIG. 9 flow diagram illustrates logic for mobile content preservation in an embodiment of the invention. Initialized 901 mobile app SDK will signal 2 the SDK to build 903 a URL to contact the Ad Provider's server. The URL will contain data parameters such as mobile user's location, number of ads and more. The SDK will attempt to contact 905 the Ad Provider's API from http://AD_SUBDOMAIN_KEY.HOSTDOMAIN.com where the AD_SUBDOMAIN_KEY is a random identifier set and known to both the display website and the Ad Provider. This identifier is stored on the Ad Provider's server. If request connection is not blocked 907 then the AD Provider searches 913 its database for a match to the AD_SUBDOMAIN_KEY received from the mobile SDK to verify that it is indeed an ad from a website client. If the request to load API 905 is blocked, unsuccessful, then the SDK will request to load 909 from the Ad Provider's better known API, for example https://ads.google.com. If the load request is not blocked 911 then the Ad provider finds 915 the ads on its server and or database meeting the website domain and other criteria, including count of ads needed for the website. The Ad Provider sends the found ads 917 to the mobile SDK where they are received 919 and placed 921 in the ad as per their iFrame or other placement directive.

While the invention has been described with respect to a limited number of embodiments, those skilled in the art, having benefit of this invention, will appreciate that other embodiments can be devised which do not depart from the scope of the invention as disclosed herein. Other aspects of the invention will be apparent from the following description and the appended claims.

What is claimed is:

1. A system for preserving web content from 3rd party blockers of specific components of the user experience in browsers or mobile apps comprising:
a user with app or browser on a network requesting a display website's URL page or URL respectively;
the website having registered a DNS subdomain and domain known to an Ad Provider having content on the website;
the website acting in concert with Ad Provider to employing a dynamically alterable path to Ad Provider serving advertising content to website users;
the ad provider creating a program dynamically altering the website ad content elements comprising ad links, CSS elements, images and ad element labels, giving a randomized programming to the ad content elements on it's server;
the ad provider's created program is downloaded to the user's browser upon request, adaptively changing the website ad component elements to the elements downloaded from the request;
the user's browser executing the ad server program to dynamically altering the display website page, and
the user's browser executing the altered display website page with the changed ad components;
whereby the advertiser content is protected from subverting blockers targeting provider ad content.

2. A system for preserving content from 3rd party subverting blockers as in claim 1 wherein the user browser is a mobile app SDK.

3. A system for preserving content from 3rd party subverting blockers as in claim 1 further comprising the website having registered a DNS subdomain and domain known to an Ad Provider having content on the website;

4. A system for preserving content from 3rd party subverting blockers as in claim 1 further comprising proxy client-servers for routing.

5. A system for preserving content from 3rd party subverting blockers as in claim 1 further comprising wildcards in subdomain entries for DNS resolution.

6. A method for preserving content from 3rd party subverting blockers of specific components of the user experience in browsers and mobile apps comprising:
a browser on a network requesting a download and display of website content;
the website using a dynamically alterable path URL to Ad Provider serving advertising content to website users via a prearranged DNS subdomain and domain names URLs;
dynamically altering the website URL and ad content elements comprising ad links, CSS elements, images and ad element labels, giving a randomized programming to the ad content elements;
creating an ad provider script or program for dynamic alteration;
user browser downloading ad provider program upon user's browser request, adaptively changing the website ad component elements to the randomized name elements, and
executing the altered display website page with the changed ad components and remaining content the website page
whereby the advertiser content is protected from subverting blockers targeting provider ad content.

7. The method for preserving advertising content from 3rd party subverting blockers as in claim 6 wherein the user browser is a mobile app SDK.

8. The method for preserving advertising content from 3rd party subverting blockers as in claim 6 further comprising the website registering a DNS subdomain and domain known to an Ad Provider;

9. A method for preserving advertising content from 3rd party subverting blockers as in claim 6 further comprising the steps of using domain proxy(ies).

10. A method for preserving advertising content from 3rd party subverting blockers as in claim 6 further comprising the steps of using wildcards in subdomain entries for DNS resolution.

11. A system for preserving web content from 3rd party blockers of specific components of the user experience in mobile browsers or apps comprising:
a user with app or browser on a network requesting a display website's URL page or URL respectively;
the website having registered a DNS subdomain and domain known to an Ad Provider having content on the website;
the website acting in concert with Ad Provider to employing a dynamically alterable path to Ad Provider serving advertising content to website users;
the ad provider creating a program dynamically altering the website ad content elements comprising ad links, CSS elements, images and ad element labels, giving a randomized programming to the ad content elements on it's server;
the ad provider's created program is downloaded to the user's browser upon request, adaptively changing the website ad component elements to the elements downloaded from the request;
the user's browser executing the ad server program to dynamically altering the display website page, and
the user's browser executing the altered display website page with the changed ad components;
whereby the advertiser content is protected from subverting blockers targeting provider ad content.
